(19) United States
(12) Patent Application Publication
(10) Pub. No.: US 2025/0319523 A1
(43) Pub. Date: Oct. 16, 2025

(54) METHOD FOR RELEASING AND TIGHTENING A SCREW CONNECTION BETWEEN A CORE DRILLING DEVICE AND A CORE BIT, AND CORE DRILLING DEVICE

(71) Applicant: Hilti Aktiengesellschaft, Schaan (LI)

(72) Inventor: Stefan RINGLER, Schwabmuehlhausen (DE)

(21) Appl. No.: 18/867,349

(22) PCT Filed: May 26, 2023
(86) PCT No.: PCT/EP2023/064237

§ 371 Date: Nov. 19, 2024

(30) Foreign Application Priority Data
Jun. 7, 2022 (EP) 22177447.4

(51) Int. Cl. B23B 31/11; B23B 45/02

(52) U.S. Cl. CPC B23B 31/11; B23B 45/02; B23B 2270/60

(57) ABSTRACT

A method for tightening or releasing a screw connection between a core drilling device and a core bit, the core drilling device including a core bit and a motor, the core bit being able to be caused to move in a first direction of rotation while, by activation of the motor during the tool change, a counter-torque is generated in order to tighten or release the twist lock between the core drilling device and the core bit. A core drilling device for carrying out the method. By activation of the motor of the core drilling device, the motor can be caused to operate counter to the movement of the core bit in the first direction of rotation. As a result, a difference between the torque in the first direction of rotation and the counter-torque can be significantly increased by activation of the motor.

The present invention relates to a method for tightening or releasing a screw connection between a core drilling device and a core bit.

### BACKGROUND OF THE INVENTION

Core drilling devices with which substantially cylindrical drill cores can be cut out of substrates to be worked, such as masonry, sand-lime brick or concrete, are known from the prior art. Lines or pipes, for example, can then be laid in or inserted into the substantially cylindrical boreholes. The core drilling devices can be connected to core bits, wherein the core bits are driven into the substrate in order to cut out the drill core.

### SUMMARY OF THE INVENTION

In conventional drilling systems made up of a core drilling device and a core bit, screw connections are used in order to fasten the core bit to the core drilling device. As a result of the significant forces that are applied during drilling, it is possible for such a screw connection to be released only with great difficulty under certain circumstances. This can be the case in particular when corrosion additionally occurs and the core bit has not been separated from the core drilling device for a relatively long time.

In the prior art, primarily three procedures are known for releasing such connections that are difficult to release between a core drilling device and a core bit. For example, it is known from the prior art to use a plurality of aids, such as wrenches with long levers, in order to generate the forces necessary for separating the core drilling device and core bit. In this case, respective wrenches are applied to the core drilling device and to the core bit, wherein the lever action can be improved by the additional use of pipes or bars. This procedure is associated with the obvious drawback that the corresponding aids each have to be carried along and can easily be lost.

Another possible way of making it easier to release a screw connection between a core drilling device and a core bit is to use what are known as “quick release rings”. These are copper and/or rubber disks that can be fitted between the core drilling device and core bit. However, such quick release rings are associated with the drawback that stiffness of the drilling system made up of the core drilling device and core bit is reduced by the use thereof. However, reduced system stiffness can lead to difficulties at the start of drilling, i.e. when starting a drilling operation.

A third possible way of making it easier to release a screw connection between a core drilling device and a core bit is to use a generous amount of lubricant. However, on account of the obvious drawbacks such as material consumption and contamination, this method is not suitable for providing a long-term satisfactory technical solution for separating the core bit from the core drilling device.

It is an object of the present invention to overcome the above-described deficiencies and drawbacks of the prior art and to provide a method and a core drilling device that allow particularly easy tightening or releasing of the core drilling device and core bit. The solution should in particular be easy to handle and not result in any additional contamination of the construction site. Above all, the invention should allow the core bit to be connected to or released from the core drilling device with as few additional aids, such as wrenches and/or pipes, as possible.

The present invention provides a method for tightening or releasing a screw connection between a core drilling device and a core bit is provided, wherein the method comprises the following method steps:
a) providing a core drilling device having
   a core bit which, during operation of the core drilling device, is fastened to the core drilling device by means of a screw connection, and
   a motor which is configured to generate a torque for driving the core bit,
b) moving the core bit in a first direction of rotation, while a counter-torque is generated when the motor is activated, in order to tighten or release the screw connection between the core drilling device and the core bit.

The basic concept of the invention is based on the interaction between the movement of the core bit in a first direction of rotation A, which is opposite to a direction B of the counter-torque. The counter-torque, which is preferably also referred to as counterholding torque in the context of the invention, is preferably generated by activation of the motor of the core drilling device during the tool change. In the context of the present invention, the term “tool change” preferably refers to the release of the core bit from the core drilling device, for example in order to exchange the core bit. When changing the tool, the screw connection between the core bit and the core drilling device is preferably released, the screw connection between the core bit and the core drilling device preferably also being referred to as a “twist lock” in the context of the present invention. By activation of the motor of the core drilling device, in which the counter-torque is generated, a possibility for simplified separation of the core bit from the core drilling device can be provided. A significant advantage of the method is that the screw connection between the core drilling device and the core bit can be released with only one additional aid, for example a wrench (see e.g. T shown solely schematically in FIG. 1). Furthermore, in the separating method, it is possible to dispense with excess use of lubricant, and so the method contributes to cost- and material-saving work on the construction site. Furthermore, unnecessary contamination by the lubricant is avoided, with the result that extensive cleaning work on the construction site can be prevented.

In addition to releasing the screw connection between a core drilling device and a core bit, the core bit can also be connected to the core drilling device with the method. In the context of the present invention, this operation is referred to as “tightening the screw connection”. When tightening the screw connection, use is also made of the fact that the drive of the power tool is blocked, rather than performing a rotational movement, and therefore the tightening of the screw connection can also be significantly simplified with the invention.

The invention also differs from conventional separation methods, as are known from the prior art, by the motor being able to be blocked by a targeted activation and the core bit then being able to be released with an aid, such as a wrench. In the context of the present invention, the blocking of the motor preferably takes place in that, when the motor is activated, a target speed for the motor is 0 revolutions per minute (rpm). This technical solution differs, for example, from other separation methods in which a deliberate change in the direction of rotation of the motor is brought about in order to use a centrifugal mass of the core bit when stopping and/or braking the motor so as to release the screw connection or the twist lock between the core drilling device and the core bit.

It is preferred in the context of the invention that, when changing the tool, the screw connection or the twist lock between the core drilling device and the core bit is released or loosened by the core bit being caused to move in a first direction of rotation, while, by activation of the motor, a counter-torque is generated with which the core bit can be released or loosened.

It is preferred in the context of the invention that the activation of the motor of the core drilling device causes the motor to operate counter to the movement of the core bit in the first direction of rotation.

As a result, the motor of the core drilling device attempts not to permit a rotational movement of the core bit; in other words, the activation of the motor prevents a rotational movement of the core bit. In this way, mechanical locking of the rotary drive of the core bit is advantageously achieved, which advantageously leads to the closing mechanism of the core bit being able to be closed. Closing the closing mechanism of the core bit advantageously leads to the motor of the core drilling device being prevented from rotating at the same time in the first direction of rotation. Instead, it is provided in the context of the present invention that the activation of the motor causes the motor to operate counter to the movement of the core bit in the first direction of rotation. The operation of the motor of the core drilling device counter to the movement of the core bit in the first direction of rotation can advantageously increase a difference between the torque directed in the first direction of rotation and the counter-torque generated by the activation of the motor. This increased difference in torque can make it much easier to release the screw connection between the core drilling device and the core bit, and consequently to make it possible in the first place. With the invention, an operation that usually takes place manually, such as releasing a core bit from the core drilling device, can be assisted with technical means and made considerably easier by skillfully exploiting technical possibilities such as activating a motor or the technical generation of a counter-torque or counter-holding torque.

It is preferred in the context of the invention that the activation of the motor of the core drilling device comprises a speed control, with a target speed for the motor of the core drilling device being 0 revolutions per minute (rpm). In this way, the difference between the torque in the first direction of rotation and the counter-torque can preferably be increased by activation of the motor of the core drilling device. It is preferred in the context of the invention that only one additional tool, such as a wrench, is required for releasing the screw connection between the core drilling device and the core bit. Said tool can be, for example, a wrench. By means of the additional tool, the twist lock of the core bit can advantageously be tightened or released such that the core bit can be removed from the core drilling device. Advantageously, the wrench can be applied to the core bit to release the core bit from the core drilling device or to connect the core bit to the core drilling device.

In a second aspect, the invention relates to a core drilling device, wherein the core drilling device is configured to carry out the method as claimed in one of the preceding claims. The terms, definitions and technical advantages introduced for the separating method apply preferably in an analogous manner to the core drilling device. With the core drilling device, a technical solution can be provided with which the number of aids required for the tool change can be reduced.

It is preferred in the context of the invention that the core drilling device comprises a motor, the motor of the core drilling device being configured to generate a torque for driving the core bit such that the core bit is caused to move in a first direction of rotation, while a counter-torque can be generated by activation of the motor in order to release the screw connection between the core drilling device and the core bit. The core bit can be connected to the core drilling device during operation of the core drilling device, while the core bit can be kept or stored separately, for example, when the core drilling device is not in operation. The core bit is therefore not a fixed component of the core drilling device, like the motor, but rather the core bit is preferably configured to be connected to the core drilling device. Consequently, the core bit is connectable to the core drilling device in order to carry out core drilling and to cut substantially cylindrical drill cores out of a substrate. The motor for generating the counter-torque is activated in particular during the tool change, i.e. when releasing the core bit from the core drilling device to which it is connected during operation of the core drilling device. In addition, the motor can be activated to generate the counter-torque when tightening the screw connection between the core bit and the core drilling device.

It is preferred in the context of the invention that a direction in which the counter-torque is oriented or points is opposed to the first direction of rotation of the core bit. The motor of the core drilling device is preferably activated in such a way that a target speed for the motor is 0 revolutions per minute (rpm). The unit “revolutions per minute” or “rounds per minute” is abbreviated to “rpm”. This advantageously generates the counter-torque which opposes the movement of the core bit in the first direction of rotation, and therefore the tightening or releasing of the screw connection or the twist lock between the core drilling device and the core bit can be made considerably easier.

It is preferred in the context of the invention that the motor of the core drilling device can be activated in such a way that the motor operates counter to the movement of the core bit in the first direction of rotation. To activate the motor, the core drilling device can comprise a control device or control electronics, the control device and the control electronics being configured to activate the motor of the core drilling device in such a way that a target speed for the motor of the core drilling device is 0 revolutions per minute (rpm). Alternatively or additionally, the control device and the control electronics can be configured to activate the motor of the core drilling device in such a way that a difference between the torque in the first direction of rotation and the countertorque is increased.

The core drilling device is preferably capable of carrying out the separation method by there being a targeted activation of the motor of the core drilling device, with which a counter-torque is generated, which significantly facilitates the tool change.

### BRIEF DESCRIPTION OF THE DRAWINGS

Further advantages will become apparent from the following description of the figures. The FIGURE, the description and the claims contain numerous features in combination. A person skilled in the art will expediently also consider the features individually and combine them to form sensible further combinations.

In the figures:

FIG. 1 shows a view of a preferred configuration of the invention

### DETAILED DESCRIPTION

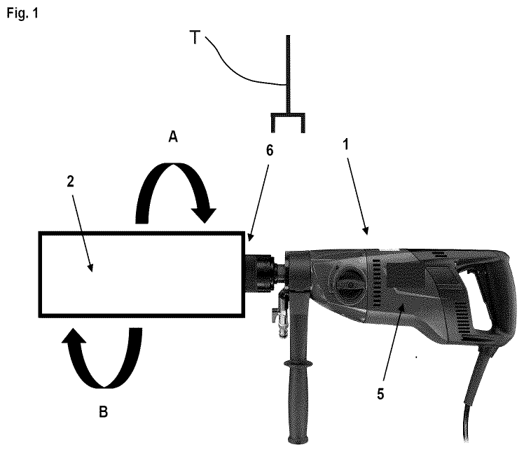

FIG. 1 shows a core drilling device 1 with which the method for connecting or separating a core bit 2 to or from a core drilling device 1 can be carried out. The connection between the core drilling device 1 and the core bit 2 is formed in particular by a screw connection 6. During operation of the core drilling device 1, i.e. when it is used for cutting drill cores out of a substrate, it is connected to a core bit 2, wherein the core bit 2 is driven into the substrate in order to cut out the drill core. For this purpose, the core bit 2 is caused to carry out a rotational movement by a motor 5 of the core drilling device 1. Provision is made for the core bit 2 to be rotated in a first direction of rotation A during the tool change, in order to release the core bit 2 from the core drilling device 1. In addition, the rotational movement of the motor 5 of the core drilling device 1 can also be used to tighten the screw connection between the core bit 2 and the core drilling device 1, i.e. to connect the core bit 2 to the core drilling device 1. In the context of the invention, this preferably means that the core bit 2 rotates, for example, in a clockwise direction. During the tool change, the motor 5 of the core drilling device 1 is activated, with the activation of the motor 5 generating a counter-torque, the counter-torque being oriented in a second direction of rotation B or pointing in a second direction of rotation B. Possible examples of a first direction of rotation A and a second direction of rotation B are indicated schematically in FIG. 1 by arrows. In the actual realization of the invention, the directions of rotation A, B can of course also be interchanged.

After work has been carried out and for transporting the core drilling device 1, it may be necessary or desired for the core bit 2 to be removed from the core drilling device 1. For this purpose, the present invention makes provision for the motor 5 of the core drilling device 1 to be blocked by a targeted activation with a target speed of 0 rpm. Through the targeted activation of the motor 5 of the core drilling device 2, a difference between the torque, which points, for example, in the first direction of rotation A, and the counter-torque, which points, for example, in the second direction of rotation B, can be increased such that a separation of the core bit 2 from the core drilling device 1 can be made considerably easier.

### LIST OF REFERENCE SIGNS

1 Core drilling device
2 Core bit
5 Motor of the core drilling device
6 Screw connection
A First direction of rotation of the core bit when changing tools
B Second direction of rotation of the counter-torque
T Wrench

1-10. (canceled)

11. A method for releasing or tightening a screw connection between a core drill and a core bit, the method comprising the following steps:
a) providing a core drilling device having a core bit, the core bit being fastened to the core drill via a screw connection during operation of the core drilling device, and the core drill having a motor configured to generate a torque for driving the core bit; and
b) moving the core bit in a first direction of rotation, while a counter-torque is generated when the motor is activated, in order to tighten or release the screw connection between the core drilling device and the core bit.

12. The method as recited in claim 11 wherein the activation of the motor causes the motor to operate counter to the movement of the core bit in the first direction of rotation.

13. The method as recited in claim 11 wherein the activation of the motor of the core drill includes a speed control, with a target speed for the motor being 0 revolutions per minute.

14. The method as recited in claim 11 wherein a difference between the torque in the first direction of rotation and the counter-torque is increased by activating the motor.

15. The method as recited in claim 11 wherein only one additional tool is required for tightening or releasing the screw connection between the core drilling device and the core bit.

16. A core drilling device configured to carry out the method as recited in claim 11.

17. The core drilling device recited in claim 16, the core drilling device comprising the core bit and the motor, the motor configured to generate a torque for driving the core bit such that the core bit is caused to move in the first direction of rotation, while the countertorque can be generated by activation of the motor in order to tighten or release the screw connection between the core drill and the core bit.

18. The core drilling device as recited in claim 16 wherein the motor is activatable in such a way that the motor operates counter to the movement of the core bit in the first direction of rotation.

19. The core drilling device as recited in claim 16 wherein the motor is activatable in such a way that a target speed for the motor is 0 revolutions per minute.

20. The core drilling device as recited in claim 16 wherein the motor is activatable in such a way that a difference between the torque in the first direction of rotation and the counter-torque is increased.
